(19) United States
(12) Patent Application Publication
(10) Pub. No.: US 2018/0197155 A1
(43) Pub. Date: Jul. 12, 2018

(54) Method and Apparatus for Processing Mobile Payment Using Blockchain Techniques

(71) Applicants: Christopher James Georgen, Kildeer, IL (US); Matthew Paul Kindy, II, Austin, TX (US); James Allen Aman, Houston, TX (US); Zihe Huang, San Francisco, CA (US)

(72) Inventors: Christopher James Georgen, Kildeer, IL (US); Matthew Paul Kindy, II, Austin, TX (US); James Allen Aman, Houston, TX (US); Zihe Huang, San Francisco, CA (US)

(73) Assignee: TOPL, LLC, Kildeer, IL (US)

(21) Appl. No.: 15/839,280

(22) Filed: Dec. 12, 2017

Related U.S. Application Data
(60) Provisional application No. 62/432,804, filed on Dec. 12, 2016.

(51) Int. Cl. G06Q 20/02; G06F 17/30

(52) U.S. Cl. CPC G06Q 20/023; G06Q 20/3223; G06F 17/30283

(57) ABSTRACT

Presently disclosed are devices and method for securely making payments using blockchain and non-blockchain components. The disclosure describes a blockchain layer which includes a transactional ledger for storing transactional information. Additionally, non-blockchain components may interact with the blockchain layer. For example, an application layer may include load balancer and application servers, API servers, a data vault, and a database, and may be used to interface between a user's electronic device and the blockchain layer. Sensitive user information, such as bank account information, social security numbers, etc., are stored in the non-blockchain components (e.g. the data vault) and are used to interface with the blockchain components to facilitate transactions.

### PRIORITY CLAIM

This application claims the benefit of Provisional Application No. 62/432,804, filed on Dec. 12, 2016, which is incorporated herein by reference.

### BACKGROUND

### Field of Invention

The present inventions relate to the processing of payments and money transfers. More particularly the present inventions relate to a network and data infrastructure that utilizes distributed blockchain and application architecture to track transactions and account balances.

### Discussion of Prior Art

The invention of Bitcoin in 2008 began a wave of interest in alternatives to traditional payment networks. This interest has centered in two areas: first, the development of public transfer networks, such as Bitcoin and Ethereum, with no relationship to traditional forms of payment and value denomination; second, the application of blockchain technology to interbank settlement and post-trade clearing and settlement, as seen in projects such as HyperLedger, R3, and Clearmatics.

Prior art methods and devices do not disclose using blockchain technology while also retaining traditional forms of denomination, such as the US dollar, to facilitate consumer payments. Prior art methods and devices rely on publicly traded cryptocurrencies, such as Bitcoin, which have the potential to substantially fluctuate relative to the US dollar and may not be controlled by any centralized authority. While there have been numerous attempts to bring Bitcoin payments to the retail space, these methods and devices have suffered from issues with timely transaction finality inherent with public blockchain networks and concerns regarding the price stability of cryptocurrencies, such as Bitcoin, with respect to the US dollar and other fiat currencies. These problems are addressed by the present inventions.

### BRIEF SUMMARY

The present inventions concern a private distributed blockchain ledger both accessible and interactable by an application layer. For reference, a blockchain network is a distributed database in which all data is time-stamped and made to be tamper-evident through the use of cryptographic hash functions.

Currently, the available methods of non-cash consumer payment are largely confined to credit and debit cards and publicly accessible cryptocurrencies. There are different but equally important advantages when comparing the present inventions to these prior methods. For example, in one or more embodiments, the inventions do not rely on other operators or partners to manage or facilitate access to the network, dissimilar to the case of credit and debit cards which rely on the close involvement of several independent parties. Additionally, in one or more embodiments, the present inventions maintain all assets and liabilities in US dollars unlike payment solutions involving Bitcoin or other publicly available cryptocurrencies.

The present inventions reduce the number of parties and steps involved in the payment process when compared to credit and debit card processing. This in turn reduces the cost involved and the need for consensus among different parties to scale or otherwise adapt the system to new circumstances. In one or more embodiments, the present inventions eliminate the need for the separation of payment processors and card associations. Additionally, in one or more embodiments, the present inventions reduce the credit risk assumed in payment processing by decreasing the time period between credit issuance and the receipt of funds.

The present inventions maintain all assets and liabilities in fiat currencies while utilizing blockchain network technology. This method of denomination is in contrast with other blockchain payment platforms, which maintain assets in cryptocurrencies, such as Bitcoin, and liabilities in fiat currencies, such as the US dollar. The invention utilizes blockchain scrips that are only valuable within the system comprised of the present inventions itself and can thus be trivially pegged to fiat currencies by the operating party. By removing the possibility for fluctuations between assets and liabilities, the risk of currency fluctuations inherent in prior art utilizing Bitcoin or other publicly traded cryptocurrencies for payment processing is removed. An object of the present inventions is to reduce the cost of payment processing as well as to reduce the security risk involved in the movement of payment information. Another object of the present inventions is to allow for increased functionality of the payment process to allow for additional functionality, such as the issuance and tracking of scrips that may be redeemed for discounts, to be added the payment process without accessory systems or processes.

### DESCRIPTION OF FIGURES

Preferred embodiments of the invention are described in detail below with reference to the attached drawing figures of exemplary scale, wherein:

FIG. 1 is a diagram of the network elements involved in the invention. This figure depicts the blockchain and application layers in addition to the connections between the inventions and external sources of information and communication.

FIG. 2 illustrates the contract sublayer of the blockchain layer. This comprises the transactional data store of the invention.

FIG. 3 shows the blockchain layer of the invention. An exemplary number of nodes is displayed (110, 304,306, 308) each containing a copy of the contract state machine detailed in FIG. 2. The nodes of the blockchain broadcast and rebroadcast new information to those nodes that do not yet contain the information. Once a specified number of nodes has received and confirmed any new information, the consensus state is iterated through a state transition as discussed in FIG. 2.

FIG. 4 depicts the flow of money through the invention, wherein Alice and Bob represent two exemplary users, either two individuals, a customer and a merchant, or two businesses. The segment of the diagram enclosed in brackets (406, 410) comprises the blockchain ledger and the application layer of the inventions.

### DETAILED DESCRIPTION OF THE INVENTIONS

Set forth below is a description of what are currently believed to be the preferred embodiments or best representative examples of the inventions claimed. Present and future modifications to the embodiments and preferred embodiments are contemplated. Any alterations or modifications which make insubstantial changes in function, purpose, structure or result are intended to be covered by the claims of this patent.

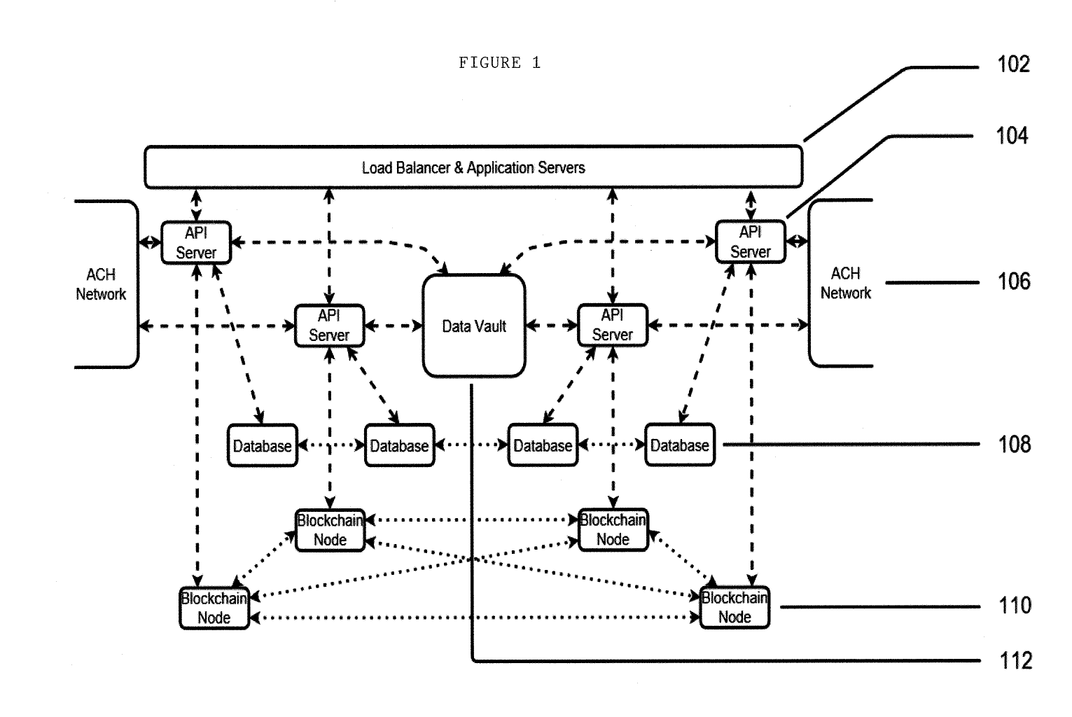

As illustrated in FIG. 1, the invention is comprised of both blockchain and non-blockchain components. The blockchain layer functions as a store for all transactional data. The non-blockchain components include computer systems configured store other information and facilitate communication between the blockchain transactional ledger and user devices as well as the Automated Clearing House (ACH) network. A person of ordinary skill in the art would understand that such computer systems include one or more processors, memories, and communication devices such as a wired or wireless modem.

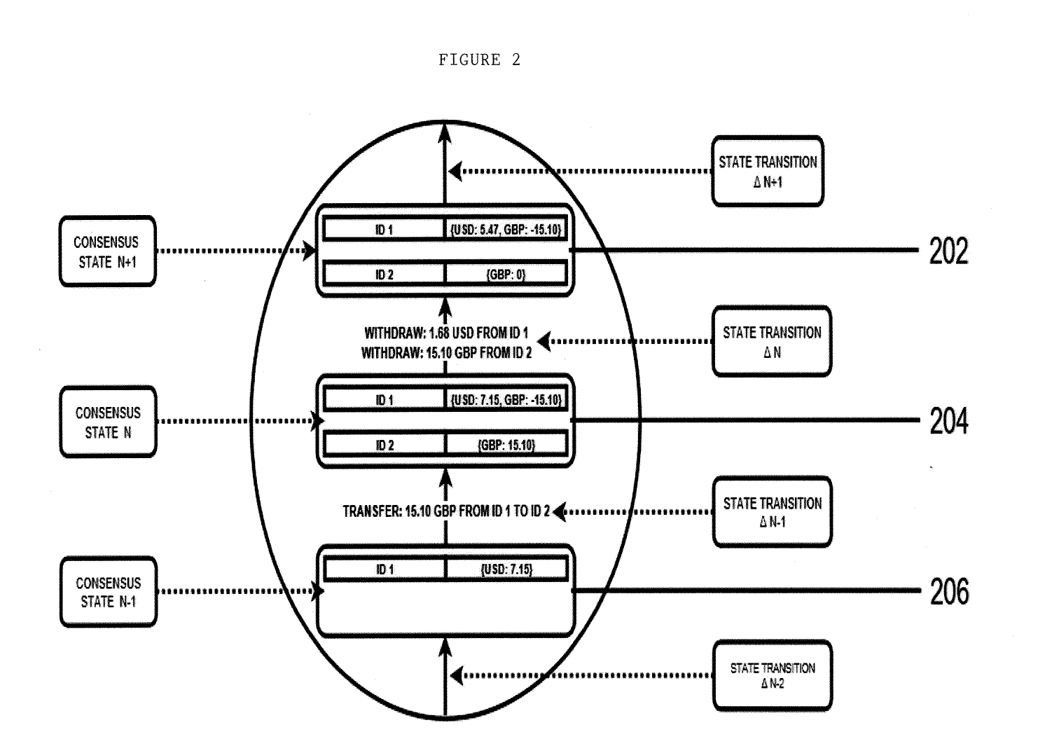

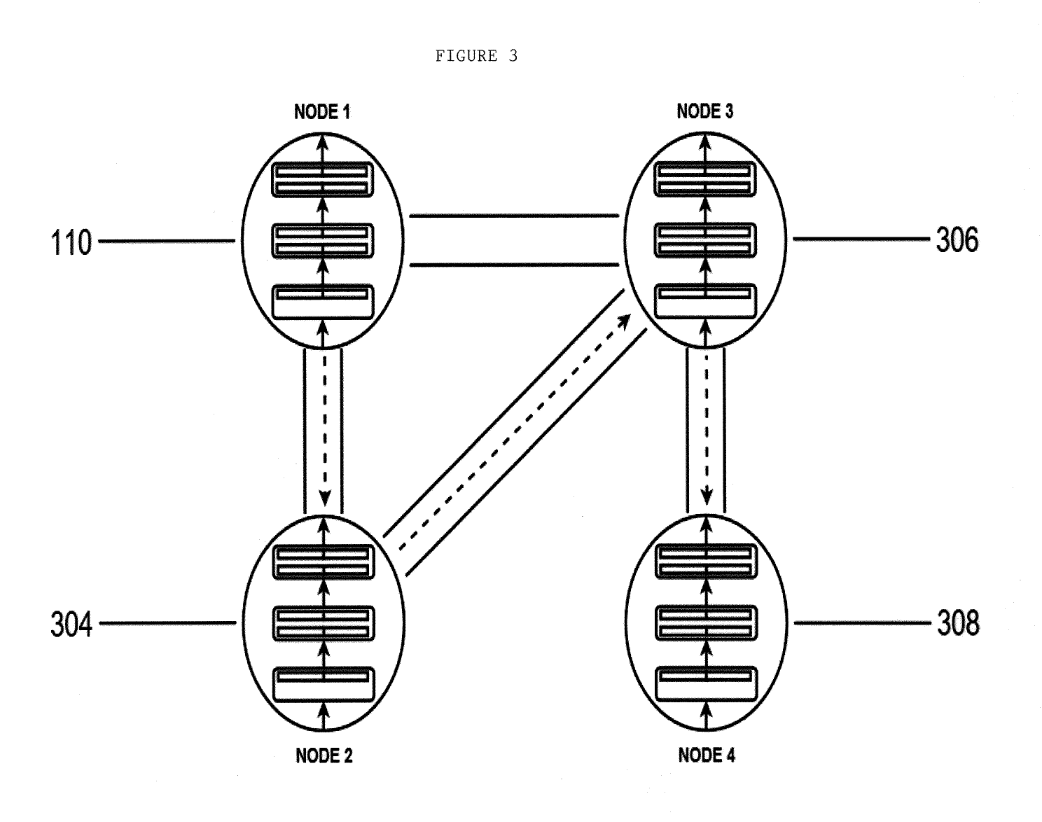

Turning to FIG. 3, the blockchain layer of the invention is defined by a plurality of physical or virtual machines, nodes, which each store a record of the state transitions, FIG. 2, in the contract sublayer. Each single node may interact with a subset of the plurality of nodes to communicate through an overlay network. A person of skill in the art would understand that an overlay network is comprised of the set of nodes in such a network and the links connecting them. As such, each node has a path through the overlay network to interact, either directly or indirectly, with every other node in the plurality. On each node, the current state of the contract sublayer may hold balance and transactional information as a ledger, with identifiers for each account associated with the contract. Association of an account to the contract means that the account is created and maintained as an address in the contract. Each contract account is mapped to information of the positive or negative scrip balance(s) for each of potentially multiple currencies or other forms of denomination for which the particular account, contract address, is enabled.

A scrip is a representation within the inventions of the quantity of a given currency or other form of denomination in a particular account or a set of accounts. A scrip balance store refers to the storage of information pertaining to an account balance denoted in scrips.

In addition to allowing for the creation and maintenance of scrip balance stores, the contract sublayer allows for increased flexibility in the variety of data types and operations supported by the blockchain layer. Such functionality includes, but is not limited to, the ability to create, destroy, or transfer scrips, the ability to create, track, store, and redeem scrips redeemable for discounts or other promotions, as well as record the transaction history and relations among any group of accounts.

The contract may be updated with the occurrence of every new set of transactions and may record the resultant effect on account balances through a process of a state transition. The contract may be recorded on each node in the blockchain network for security and data redundancy, where a node consists of storage space, a processor, and network connectivity. In one embodiment, the contract sublayer allows for account balances to be denominated in multiple fiat currencies with positive as well as negative balance amounts.

In addition to the mutative functions already described, the contract sublayer maintains a transactional event store that can be accessed by the application layer to retrieve transactional history. Furthermore, the usage of scrips managed through smart contracts, as opposed to native blockchain currencies, allows for the maintenance of negative balances, i.e. the extension of credit, for individual contract accounts and the ability to associate those accounts with arbitrary properties that can be referenced by the application layer.

While blockchain consensus algorithms dramatically differ, the present inventions are not dependent on a particular consensus algorithm. Because the native blockchain protocols utilized in the invention operate independently of the application layer, and vice versa, the specific consensus algorithm of the blockchain layer does not impact the functionality of the invention. This is the result of the contract sublayer behaving as an API for the application layer, so that all aspects of the native blockchain protocol are abstracted away from the interaction between the blockchain and application layers.

Various consensus algorithms are contemplated as being within the scope of the present inventions. A suitable consensus algorithm may include the ability for the contract sublayer stored on any individual blockchain to communicate with the contract sublayer stored on each of the other blockchains within the invention (inter-chain operability) for scalability and modularity; the existence of a contract sublayer with smart contracts that can be updated by linkage to other smart contracts (dynamically linked contracts) for flexibility; and the issuance of currency scrips that are assigned a redemption value denominated in a base unit of a specific fiat currency while also having appropriate redemption value in any currency (fiat-denominated scrips).

As shown in FIG. 1, the application layer may be comprised of the Load Balancer & Application Servers (102), the API Servers (104), the Data Vault (112), and Database (108), along with their interactions. These components together comprise the application layer of the invention. The application layer serves both to interface directly with user electronic devices, such mobile phones, tablets, payment terminals, and computers, and to execute business and user logic related actions including but not limited to initiating bank transfers and pre-processing and transmitting user payments to the blockchain.

The Load Balance and Application Servers function to pass information between user electronic devices and other components of the inventions. The API Servers act to pass information between different components of the inventions. Sensitive user data, such as bank account information, social security numbers, and Tax Identification Numbers are stored in encrypted or tokenized form within a secure Data Vault. In one embodiment of the invention, a relational Database using SQL stores non-sensitive user information such as name, phone number, and other identifying or usage data.

The contract sublayer, as shown in FIG. 3, is the store of the transaction history for the present inventions as well as the balances of all accounts. This information is tied to the appropriate user account by a mapping between account identifiers used in the contract sublayer and the database.

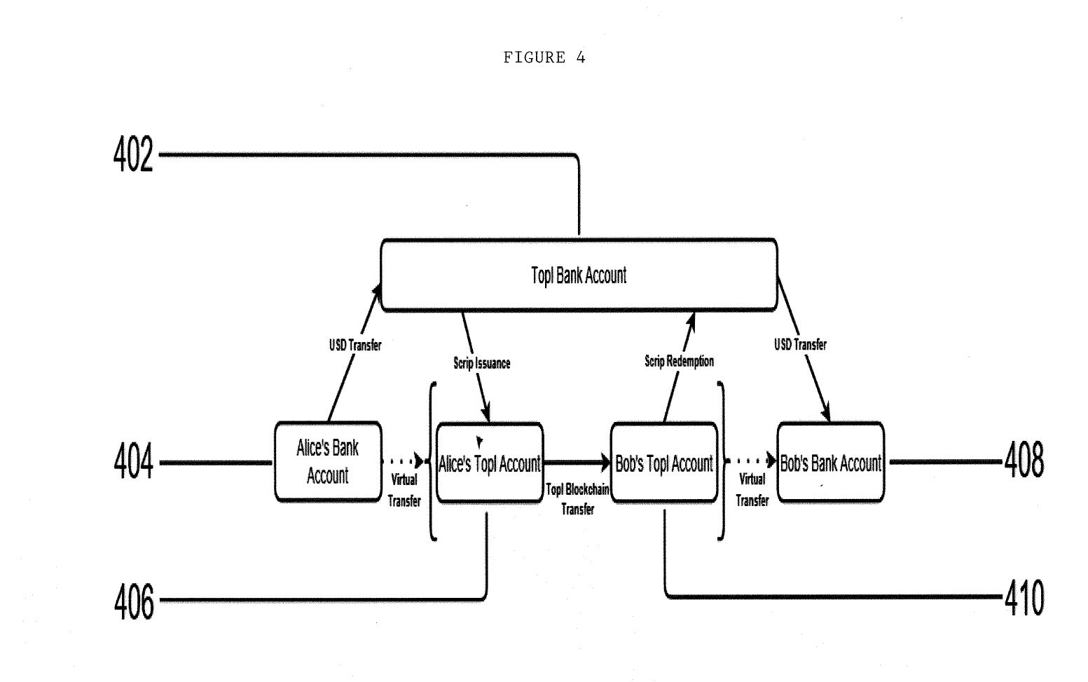

A set of the interactions between these layers in one embodiment of the invention can be summarized as shown in FIG. 4, where a bank funds transfer is initiated through the application layer to the scrip issuer's bank account. During this process, the application layer invokes the blockchain layer to trigger a scrip issuance through its contract sublayer for the contract account on the blockchain layer associated with the user account on the application layer. When a transfer request occurs on the application layer, the blockchain layer triggers a scrip transfer through the contract sublayer. Finally, upon receipt of a request to retrieve funds from the network on the application layer, the blockchain layer triggers a scrip redemption through the contract sublayer for the specified account and the application layer prepares a funds transfer to the user bank account.

By way of non-limited example, three exemplary processes are detailed herein: deposit into an account, transfer between accounts, and withdrawal from an account.

In the event that a user with an account wishes to deposit money from a bank account into his account within the system the following steps occur.
1. User request to add money from bank account to their account within the system received by Load Balancer & Application Servers, 102.
2. Request routed from Load Balancer & Application Servers, 102, to an API Server, such as 104.
3. An API Server, 104, retrieves relevant user information and any information required to access bank account data from Database, 108, and from Data Vault, 112.
4. Necessary bank account information is retrieved from Data Vault, 112, and passed along with amount to be deposited through an API Server, 104, to ACH or another external financial network, 106.
5. Upon confirmation from ACH or other external financial network, 106, user account is updated by an API Server 104, communicating to a Blockchain Node, 110.
6. Deposit and newly updated user balance are sent from original Blockchain Node, 110, to all other Blockchain Nodes (304, 306, 308).
7. Blockchain undergoes state transition N−2 into 206.
8. State transition is recognized by an API Server, 104, and information is passed through Load Balancer & Application Servers, 102, informing the user of the successful deposit and new account balance.
   In the event that one user (Alice) wishes to send an amount from her account to another user (Bob) the following steps occur.
1. Alice's request to send amount to Bob received by Load Balancer & Application Servers, 102.
2. Request routed from Load Balancer & Application Servers, 102, to an API Server, such as 104.
3. An API Server, 104, retrieves relevant user information for Alice and Bob from Database, 108.
4. API server passes transfer request to a Blockchain Node, 110.
5. Transaction and newly updated user balances for Alice and Bob are sent from original Blockchain Node, 110, to all other Blockchain Nodes (304, 306, 308).
6. Blockchain undergoes state transition N−1 into 204.
7. State transition is recognized by an API Server, 104, and information is passed through Load Balancer & Application Servers, 102, informing the users of the successful transfer and their new balances.
   In the event that a user with an account wishes to withdraw money from his account within the system to a bank account the following steps occur.
1. User request to withdraw money from his account within the system to a bank account received by Load Balancer & Application Servers, 102.
2. Request routed from Load Balancer & Application Servers, 102, to an API Server, such as 104.
3. An API Server, 104, retrieves relevant user information and any information required to access bank account data from Database, 108, and from Data Vault, 112, respectively.
4. Necessary bank account information is retrieved from Data Vault, 112, and passed along with amount to be withdrawn through an API Server, 104, to ACH r another external financial network, 106.
5. Upon confirmation from ACH or other external financial network, 106, user account is updated by an API Server, 104, communicating to a Blockchain Node, 110.
6. Withdrawal and newly updated user balance are sent from original Blockchain Node, 110, to all other Blockchain Nodes (304, 306, 308).
7. Blockchain undergoes state transition N into 202.
8. State transition is recognized by an API Server, 104, and information is passed through Load Balancer & Application Servers, 102, informing the user of the successful withdrawal and new account balance.

While the description above disclosed particular embodiments of the inventions, it should be understood that any of the features of any of the embodiments of the present disclosure may be combined with any features of other embodiments of the present disclosure.

It will be appreciated by those skilled in the art that while the invention has been described above in connection with particular embodiments and examples, the invention is not necessarily so limited, and numerous other embodiments, examples, uses, modifications and departures from the embodiments, examples and uses are intended to be encompassed by the claims attached hereto.

What is claimed:

1. A computer system comprising computer hardware for processing transactions, the computer system further comprising:
a blockchain layer configured to store all transactional data in a transactional ledger, wherein the blockchain layer comprises a plurality of physical or virtual machines; and
a non-blockchain component further comprising at least one processor operably connected to at least one memory and at least one modem, the processor being configured to facilitate communication between the transactional ledger, at least one user device, and an Automated Clearing House (ACH) network.

2. The computer system of claim 1, wherein the non-blockchain component further comprises an application layer comprising a load balancer and application server, an API server, a data vault, and a database.

3. The computer system of claim 2, wherein the plurality of physical or virtual machines of the blockchain layer each store a record of state transitions in a contract sublayer associated with a contract.

4. The computer system of claim 3, wherein the contract sublayer includes at least balance and transactional information having identifiers for each account associated with the contract.

5. The computer system of claim 4, wherein each account is mapped to information indicative or a positive or negative scrip balance.

6. The computer system of claim 5, wherein the contract sublayer is configured to include at least the functions of creating and destroying scrips.
